(19) United States
(12) Patent Application Publication
(10) Pub. No.: US 2023/0178861 A1
(43) Pub. Date: Jun. 8, 2023

(54) SECONDARY BATTERY

(71) Applicant: Samsung SDI Co., Ltd., Yongin-si (KR)

(72) Inventors: Hyun Soo LEE, Yongin-si (KR); Jun Sun YONG, Yongin-si (KR)

(21) Appl. No.: 17/875,248

(22) Filed: Jul. 27, 2022

(30) Foreign Application Priority Data
Dec. 8, 2021 (KR) 10-2021-0174747

(51) Int. Cl. H01M 50/54; H01M 50/15; H01M 50/553; H01M 50/536

(52) U.S. Cl. CPC H01M 50/54; H01M 50/15; H01M 50/553; H01M 50/536

(57) ABSTRACT

A secondary battery, according to embodiments of the present disclosure, exhibits a reduced decrease in capacity by slimming a current collecting structure. By reducing the space occupied by the current collecting structure in the longitudinal direction of an electrode assembly, the size of the electrode assembly may be increased.

### CROSS-REFERENCE TO RELATED APPLICATION

This application claims priority to and the benefit of Korean Patent Application No. 10-2021-0174747, filed on Dec. 8, 2021, in the Korean Intellectual Property Office, the entire content of which is herein incorporated by reference.

### BACKGROUND

### 1. Field

Aspects of embodiments of the present disclosure relate to a secondary battery.

### 2. Description of the Related Art

Different from primary batteries, which are not designed to be recharged, secondary batteries are designed to be charged (e.g., recharged) and discharged. Low-capacity secondary batteries in which one battery cell is packaged in the form of a pack are widely employed in small sized portable electronic devices, such as mobile phones, camcorders, etc. while a large-capacity secondary battery module in the form of a battery pack unit in which dozens of battery packs are connected to one another is typically used for driving motors of hybrid automobiles, electric automobiles, etc.

The secondary battery may be configured by incorporating an electrode assembly stacked or wound with a separator interposed between positive and negative electrode plates into a case with an electrolyte and then installing a cap plate in (or on) the case. In the electrode assembly, a non-coating (or non-coated) portion tab may protrude laterally or upwardly, and a current collecting structure may be connected to the non-coating portion tab.

However, due to the thickness or size of the current collecting structure, the capacity of the secondary battery is inevitably reduced corresponding to the space occupied by the current collecting structure.

The above information disclosed in this Background section is only for enhancement of understanding of the background of the present disclosure, and therefore, it may contain information that does not constitute prior art.

### SUMMARY

An embodiment of the present disclosure provides a secondary battery exhibiting a slimmed a current collecting structure to reduce or minimize a corresponding decrease in capacity.

A secondary battery, according to an embodiment of the present disclosure, includes: a case having an opening at one side thereof; an electrode assembly accommodated in the case and including a first electrode plate having a first substrate tab on one side in the longitudinal direction of the case, a second electrode plate having a second substrate tab on another side in the longitudinal direction of the case, and a separator between the first electrode plate and the second electrode plate; and a cap assembly including a cap plate coupled to the case at the opening therein, a first current collecting unit and a second collecting including a first current collector and a second current collector parallel to the upper end in the longitudinal direction of the electrode assembly and electrically connected to the first electrode substrate tab and the second electrode substrate tab, respectively, a first terminal part and a second terminal part electrically connected to the first current collecting unit and the second current collecting unit, respectively, and a plurality of insulating members coupled to at least one of the cap plate, the first current collector, the second current collector, the first terminal part and the second terminal part.

The first current collecting unit may further include: a connection plate electrically connected to the first current collector and having one end bent in the direction of the first substrate tab; and a sub-plate electrically connected to the connection plate and the first substrate tab. The second current collecting unit may further include: a connection plate electrically connected to the second current collector and having one end bent in the direction of the second substrate tab; and a sub-plate electrically connected to the connection plate and the second substrate tab.

The sub-plate of the first current collecting unit may include a first connection part electrically connected to the connection plate and a second connection part electrically connected to the first substrate tab, and the sub-plate of the second current collecting unit may include a first connection part electrically connected to the connection plate and a second connection part electrically connected to the second substrate tab.

One end of the connection plate and the first connecting part of the sub-plate may be welded to each other.

The welded portion of the connection plate and the sub-plate may be closer to the bottom surface of the case than to the top end of the electrode assembly.

The second connection part of the sub-plate may be bent toward the electrode assembly from the first connection part, and the bent portion may be closer to the bottom surface of the case than to the top end of the electrode assembly.

A plate surface of the second connection part facing the electrode assembly may be on the same plane as a plate surface of the connection plate facing the electrode assembly.

A plate surface of the second connection part facing the electrode assembly may be closer to the electrode assembly than to a plate surface of the connection plate facing the electrode assembly.

The second connection part may have a welding groove concavely formed on the plate surface facing the case.

A thickness of the first current collector or the second current collector may be greater than a thickness of the connection plate and the sub-plate.

The thickness of the first current collector or the second current collector may be about four to five times that of the connection plate and the sub-plate.

A secondary battery, according to an embodiment of the present disclosure, includes an electrode assembly; a case accommodating the electrode assembly; and a cap assembly coupled to the case, electrically connected to the electrode assembly, and having a first current collector and a second current collector parallel to the upper end of the electrode assembly.

The cap assembly may include: a cap plate coupled to the case; a first current collecting unit including a sub-plate electrically connected to a first substrate tab provided on the first electrode plate of the electrode assembly and a connection plate electrically connected to the first current collector and the corresponding sub-plate; a second current collecting unit including a sub-plate electrically connected to a second substrate tab provided on the second electrode plate of the electrode assembly and a connection plate electrically connected to the second current collector and the corresponding sub-plate; a first terminal part including a first terminal pin coupled to the first current collector and electrically connected thereto and a first terminal plate coupled to the first terminal pin and electrically connected to the first terminal plate; a second terminal part including a second terminal pin coupled to the second current collector and electrically connected thereto, a second terminal plate coupled to the second terminal pin and electrically connected to the second terminal plate, and a conductive plate; and an insulating member including an insulating material between the cap plate and the first current collector, between the first current collector and the electrode assembly, between the second current collector and the electrode assembly, and between the first terminal pin and the second terminal pin and the cap plate, respectively.

The connection plate may have one end parallel to the first current collector or the second current collector and another end bent toward the electrode assembly, and the sub-plate may be welded to an end of the bent portion.

The sub-plate may include a first connection part welded to the connection plate and a second connection part bent from the first connection part toward the electrode assembly and electrically connected to the electrode assembly.

The second connection part may be on the same plane as the connection plate or closer to the electrode assembly than to the connection plate.

The thickness of the first current collector or the second current collector may be greater than that of the connection plate and the sub-plate.

### BRIEF DESCRIPTION OF DRAWINGS

FIG. 1 is a perspective view of a secondary battery according to an embodiment of the present disclosure.

FIG. 2 is an exploded perspective view of a cap assembly of the secondary battery shown in FIG. 1.

FIG. 3 is a cross-sectional view of the secondary battery shown in FIG. 1.

FIG. 4 is an enlarged cross-sectional view of a part of FIG. 3.

### DETAILED DESCRIPTION

Embodiments of the present disclosure are provided to more completely explain the present disclosure, and the following embodiments may be embodied in many different forms and should not be construed as being limited to the embodiments set forth herein. Rather, these example embodiments are provided so that this disclosure will be thorough and complete and will fully convey the aspects and features of the present disclosure to a person skilled in the art.

In the accompanying drawings, sizes or thicknesses of various components may be exaggerated for brevity and clarity. Like numbers refer to like elements throughout. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof. It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the term “below” can encompass both an orientation of above and below.

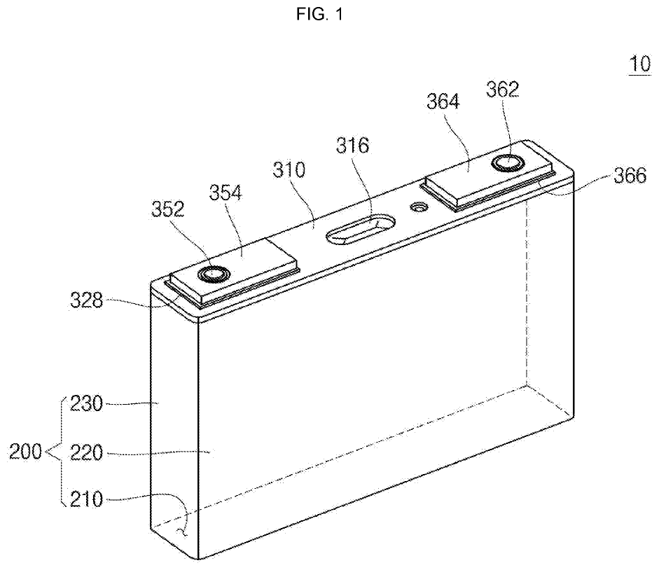

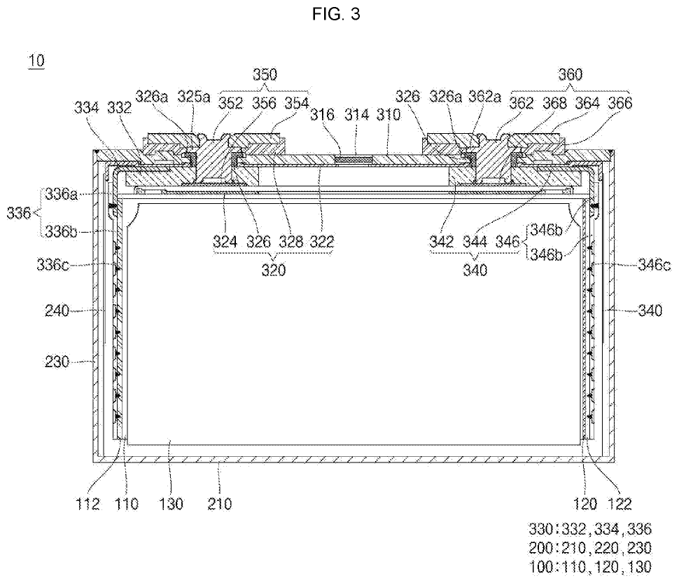

Hereinafter, a secondary battery according to embodiments of the present disclosure will be described, in detail, with reference to the accompanying drawings. For convenience, on the basis of FIGS. 1 and 3, the upper side is defined as an upper portion and the lower side is defined as a lower portion.

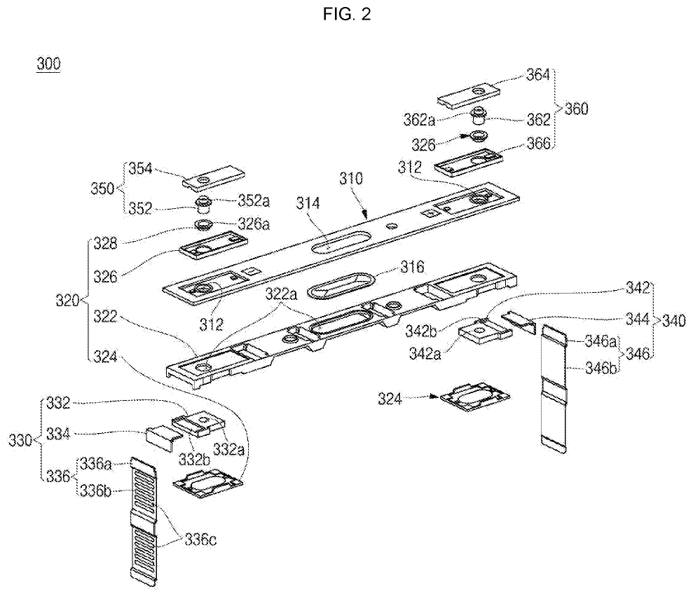

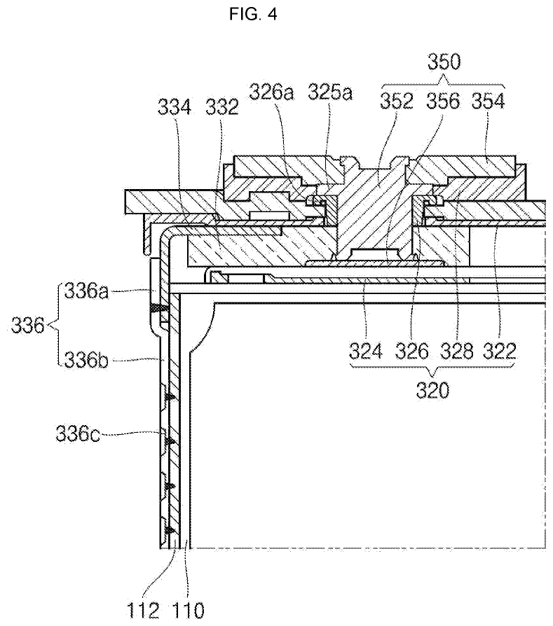

FIG. 1 is a perspective view of a secondary battery according to an embodiment of the present disclosure, FIG. 2 is an exploded perspective view of a cap assembly of the secondary battery shown in FIG. 1, FIG. 3 is a cross-sectional view of the secondary battery shown in FIG. 1, and FIG. 4 is an enlarged cross-sectional view of a part of FIG. 3.

As shown in FIGS. 1-3, the secondary battery 10, according to an embodiment of the present disclosure, may include an electrode assembly 100, a case 200 accommodating the electrode assembly 100, and a cap assembly 300 coupled to the case 200.

Referring to FIG. 3, the electrode assembly 100 may be provided by winding a unit stack including a first electrode plate 110 and a second electrode plate 120 with a separator 130 interposed therebetween or by stacking a plurality of unit stacks. When the electrode assembly 100 is formed by winding, the winding axis may be in the horizontal direction and substantially parallel to the longitudinal direction of the cap assembly 300 or in the vertical direction and substantially perpendicular to the longitudinal direction of the cap assembly 300. When the electrode assembly 100 is formed by stacking, long side surfaces of the plurality of unit stacks may be disposed to be adjacent to each other.

For example, the first electrode plate 110 may be a negative electrode and the second electrode plate may be a positive electrode, or vice versa.

When the first electrode plate 110 is a negative electrode plate, the first electrode plate 110 may be formed by applying a first electrode active material, such as graphite or carbon, on a first electrode current collector provided with a metal foil, such as copper, a copper alloy, nickel, or a nickel alloy. A first substrate tab (e.g., a first non-coating portion), which is a region to which the first electrode active material is not applied, may be provided on the first electrode plate 110. A plurality of first substrate tabs 112 may be gathered together and tack-welded, and the tack-welded first substrate tabs 112 and the cap assembly 300 may then be electrically connected. For example, the first substrate tabs 112 may become passages for current flow between the first electrode plate 110 and a first terminal part 350 of the cap assembly 300.

When the second electrode plate 120 is a positive electrode plate, the second electrode plate 120 may be formed by applying a second electrode active material, such as a transition metal oxide, on a second electrode current collector provided with a metal foil, such as aluminum or an aluminum alloy. A second substrate tab (e.g., a second non-coating portion), which is a region to which the second electrode active material is not applied, may be formed on the second electrode plate 120. A plurality of second substrate tabs 122 may be gathered together and tack-welded, and the tack-welded second substrate tabs 122 and the cap assembly 300 may then be electrically connected. For example, the second substrate tabs 122 may become passages for current flow between the second electrode plate 120 and a second terminal part 360 of the cap assembly 300.

In some embodiments, the first substrate tab 112 and the second substrate tab 122 may be formed by cutting first sides of the first electrode plate 110 and the second electrode plate 120 when manufacturing the first electrode plate 110 and the second electrode plate 120, respectively. For example, the first substrate tab 112 may be integrally formed with the first electrode plate 110, and the second substrate tab 122 may be integrally formed with the second electrode plate 120. The first substrate tab 112 may be disposed in one direction of the electrode assembly 100, and the second substrate tab 122 may be disposed in the other direction of the electrode assembly 100. For example, as in FIG. 3, the first substrate tab 112 is disposed to face the left-end surface of the case 200, and the second substrate tab 122 is disposed to face the right-end surface of the case 200.

The separator 130 is disposed between the first electrode plate 110 and the second electrode plate 120 to prevent a short circuit and enable movement of lithium ions. For example, the separator 130 may include polyethylene, polypropylene, or a composite film of polyethylene and polypropylene. In some embodiments, the separator 130 may be an inorganic solid electrolyte, such as a sulfide-based, oxide-based, or phosphate-based electrolyte such that a liquid or gel electrolyte may be omitted.

The electrode assembly 100 may be accommodated in the case 200 together with the electrolyte. In some embodiments, the electrolyte may include a lithium salt, such as LiPF₆ or LiBF₄, in an organic solvent, such as ethylene carbonate (EC), propylene carbonate (PC), diethyl carbonate (DEC), ethyl methyl carbonate (EMC), or dimethyl carbonate (DMC). In addition, the electrolyte may be in a liquid or gel phase. In some embodiments, when an inorganic, solid electrolyte is used, the (liquid or gel) electrolyte may be omitted.

As shown in FIGS. 1 and 3, the case 200 has a substantially rectangular parallelepiped box shape with an upper portion in the longitudinal direction that is open and an accommodating space formed therein. The electrode assembly 100 and the electrolyte may be inserted into the case 200 through the opened upper portion and accommodated therein. Some components of the cap assembly 300 may be exposed to the outside of the case 200, and some other components may be accommodated inside the case 200. The case 200 may have a rectangular bottom surface 210 and four side surfaces connected to (or extending vertically from) the bottom surface 210. The side having a relatively large area is defined as a long side portion 220, and the side having a relatively small area is defined as a short side portion 230. For example, the electrode assembly 100 may be disposed such that the plate surface thereof faces the long side portion 220. After the electrode assembly 100 is accommodated in the case 200, the cap assembly 300 is coupled to the case 200 and electrically connected to the electrode assembly 100. In some embodiments, an insulating film 240 for insulation from a current collecting unit may be coupled (or attached) to the short side portion 230 of the case 200.

As shown in FIGS. 1 to 4, the cap assembly 300 may include a cap plate 310 coupled to the case 200, a plurality of insulating members, a first current collecting unit 330, a second current collecting unit 340, a first terminal part 350, and a second terminal part 360.

As shown in FIG. 2, the cap plate 310 has a substantially rectangular plate shape. The cap plate 310 may be formed of the same material as the case 200. For example, the cap plate 310 may be sized to correspond to the inner size of the opening of the case 200. In addition, for example, the cap plate 310 may be coupled to the case 200 by laser welding, etc. The cap plate 310 may have terminal holes (e.g., terminal openings) 312 to be coupled with the first terminal part 350 and the second terminal part 360, respectively, grooves, and injection holes (or injection openings) formed therein and a vent hole (e.g., a vent opening) 314 for coupling a vent 316. When the internal pressure of the secondary battery 10 rises above a reference pressure, the vent 316 may burst to discharge gas. A general vent structure may be applied as the vent 316.

The insulating member includes an insulation plate 322, a pair of lower insulation parts 324, a pair of pin insulation parts 326, and one upper insulation part 328. All of the insulating members are made of an insulating material and may be manufactured by, for example, an injection process.

The insulation plate 322 has a substantially rectangular plate shape. The insulation plate 322 is in close contact with (e.g., directly contacts) the lower surface of the cap plate 310 to insulate the cap plate 310 from the electrode assembly 100. In addition, the insulation plate 322 insulates between the current collecting structure and the cap plate 310, which will be described in more detail later. Accordingly, the insulation plate 322 may have side surfaces extending downwardly along the edges thereof. The side surfaces may be shaped to connect the entire edges of the insulation plate 322 (e.g., to extend along the entire edge of the insulation plate 322) or may be formed only partially (e.g., only partially along the edge of the insulation plate 322). The insulation plate 322 may have different shapes of the plate surface or the side surfaces, according to the shapes of components to be insulated. The insulation plate 322 has through holes (e.g., openings) 322a located to correspond to the terminal holes 312 and the vent hole 314 of the cap plate 310. A portion of the current collection part and the lower insulation part 324 may be disposed under the insulation plate 322.

The lower insulation part 324 is for insulation of some components of the current collector and has a substantially rectangular plate shape. The lower insulation part 324 may be provided as a pair and may be disposed on the sides of the first terminal part 350 and the second terminal part 360, respectively. In addition, the lower insulation part 324 is disposed under current collectors 332 and 342, to be described in more detail later, and may be formed to have a size large enough to substantially cover the current collectors 332 and 342. The lower insulation part 324 may be coupled to the insulation plate 322 in a state in which the current collectors 332 and 342 are assembled.

The pin insulation part 326 insulates between the terminal pins 352 and 362 of the first terminal part 350 and the second terminal part 360 and the cap plate 310, to be described in more detail later, and has a substantially cylindrical shape. The upper insulation part 328 has a flange 326a extending outwardly from the upper end of the outer circumferential surface thereof. The flange 326a is in contact with the lower portions of the first sides of the terminal pins 352 and 362, and the lower end of the upper insulation part 328 is inserted into the through hole 322a of the insulation plate 322.

The upper insulation part 328 is a configuration applied to the first terminal part 350 and may not be applied to the second terminal part 360. The upper insulation part 328 is disposed between the first terminal plate 354 and the cap plate 310 to be described later. The upper insulation part 328 may have a rectangular plate shape substantially corresponding to the shape of the first terminal plate 354. The upper insulation part 328 is formed to be larger than the first terminal plate 354 and has a groove in which the first terminal plate 354 is seated. A hole (e.g., an opening) is formed through the upper insulation part 328 at a position corresponding to the terminal hole 312 in the cap plate 310. A flange 352a of the first terminal pin 352 is disposed in the through hole.

As shown in FIGS. 2 to 4, the first current collecting unit 330 electrically connects the first electrode plate 110, which is a negative electrode plate, to the first terminal part 350. The first current collecting unit 330 may include a first current collector 332 electrically connected to the first terminal part 350, a connection plate 334 electrically connected to the first current collector 332, and a sub-plate 336 electrically connected to the connection plate 334 and the first substrate tab 112.

The first current collector 332 may be made of a conductive material having a reference (e.g., a preset or predetermined) thickness and may have a substantially plate shape. In addition, the first current collector 332 has a plate that is not bent (or has no bent portion). The first current collector 332 has a through hole (e.g., an opening) 332a at positions corresponding to the terminal hole 312 in the cap plate 310 and the through hole 322a in the insulation plate 322. A first terminal pin 352, to be described in more detail later, is inserted into the through hole 332a. A portion of the upper surface of the first current collector 332 is in contact with the lower surface of the insulation plate 322, and the lower surface of the first current collector 332 is insulated from the electrode assembly 100 by the lower insulation part 324. The connection plate 334 is in contact with one side of the upper surface of the first current collector 332. To this end, a seating groove 332b may be concavely formed on one side of the upper surface of the first current collector 332. Because the seating groove 332b has a depth corresponding to the thickness of the connection plate 334, the upper surface of the connection plate 334 and the upper surface of the first current collector 332 may be disposed on the same plane. For example, the vertical thickness of the first current collector 332 may be four to five times the thickness of the connection plate 334 and the sub-plate 336.

The connection plate 334 may be made of a conductive material having a relatively larger thickness than that of the first current collector 332 and may have a substantially vertically bent shape. The upper side of the connection plate 334 on the basis of the bent portion is defined as an upper portion, and a portion extending downwardly is defined as a lower portion. The lower surface of the upper portion of the connection plate 334 is seated in the seating groove 332b, which is formed on the upper surface of the first current collector 332, and the upper surface of the upper portion is in close contact with the lower surface of the insulation plate 322. The outer surface of the lower portion of the connection plate 334 is in contact with one side of the sub-plate 336. When the first current collector 332 is fixed in a state in which the connection plate 334 is seated on the first current collector 332, the connection plate 334 may also be fixed between the insulation plate 322 and the first current collector 332. Accordingly, the connection plate 334 may be physically and electrically connected to the first current collector 332 without being separately welded. In some embodiments, however, the connection plate 334 may be connected to the first current collector 332 by laser welding. The connection plate 334 and the sub-plate 336 may be connected by laser welding, etc. To prevent damage to the insulation plate 322 during welding, the lower end of the connection plate 334 may be disposed at a lower position than the upper end of the electrode assembly 100, and the welded portion may also be formed adjacent to the lower end of the connection plate 334 (e.g., may be placed closer to the bottom of the case 200).

The sub-plate 336 may be made of a conductive material having a width and length and may have a substantially plate shape. One end (e.g., a top end) of the sub-plate 336 may be in contact with a lower portion of the connection plate 334 and welded. When the surface facing the electrode assembly 100, from among the plate surfaces of the sub-plate 336, is defined as the inner surface, and the surface facing the short side portion 230 of the case 200 is defined as the outer surface, the first substrate tab 112 may be connected to the inner surface. A portion where the sub-plate 336 is connected to the connection plate 334 may be defined as a first connection part 336a and a portion connected to the first substrate tab 112 may be defined as a second connection part 336b. In the sub-plate 336, the first connection part 336a and the second connection part 336b may be bent at an angle (e.g., at a predetermined angle). For example, the inner surface of the second connection part 336b may be bent toward the electrode assembly 100 from the first connection part 336a and disposed on the same plane as the inner surface of the connection plate 334. In some embodiments, the inner surface of the second connection part 336b may be disposed more inwardly toward the electrode assembly 100 than the inner surface of the connection plate 334. The inner surface of the second connection part 336b may be connected to the first substrate tab 112 by welding. Accordingly, the vertical length of the second connection part 336b may be formed to correspond to or may be slightly larger than the vertical length of the first substrate tab 112. The width of the second connection part 336b may be formed to correspond to or to be slightly larger than that obtained by welding the first substrate tabs 112 together. In addition, a plurality of concave welding grooves 336c may be formed on the outer surface of the second connection part 336b. The welding grooves 336c may include a plurality of welding grooves formed along (or extending along) the width direction, with reference to FIG. 2, of the second connection part 336b. Welded portions of the second connection part 336b and the first substrate tabs 112 may be formed on the welding grooves 336c. For example, when the thickness of the first current collector 332 is about 3.5 mm, the connection plate 334 and the sub-plate 336 may be formed to have a thickness of about 0.8 mm.

As described above, because the relatively thick first current collector 332 is formed in a straight line and the connection plate 334 and the sub-plate 336 are relatively thin, the size of the electrode assembly 100 can be increased.

As shown in FIGS. 1 to 4, the first terminal part 350 may include a first terminal pin 352 and a first terminal plate 354. In some embodiments, the first terminal part 350 may further include a fixing plate 356 for fixing the first terminal pin 352.

The first terminal pin 352 has a substantially cylindrical shape and is electrically connected to the first current collector 332 and, thus, can be electrically connected to the first electrode plate 110 of the electrode assembly 100. The first terminal pin 352 has a flange 352a, on which the first terminal plate 354 is seated adjacent to the upper end thereof. The flange 352a extends outwardly in the vertical direction from the outer circumferential surface of the first terminal plate 354. The upper and lower surfaces of the flange 352a may be substantially parallel to the cap plate 310. A portion of the lower surface of the first terminal plate 354 may be in contact with the upper surface of the flange 352a, and the upper surface of the flange 326a of the pin insulating part 326 may be in contact with the lower surface of the flange 352a. When the pin insulating part 326 is inserted into the cap plate 310 during manufacture, the lower portion of the first terminal pin 352 may be sequentially inserted through the upper insulation part 328, the cap plate 310, the insulation plate 322, and the first current collector 332. Thereafter, the first terminal plate 354 may be seated on the upper portion of the flange 352a, and the upper and lower ends of the first terminal pin 352 may be pressed and deformed, thereby fixing the first terminal pin 352 with the first terminal plate 354 with the first current collector 332. Then, when necessary, the lower end of the first terminal pin 352 and a portion of the lower surface of the first current collector 332 may be welded to fix the first terminal pin 352 and the first current collector 332. In other embodiments, the fixing plate 356 may be closely attached to the lower end of the first terminal pin 352, and the fixing plate 356 and the lower end of the first terminal pin 352 and the first current collector 332 may be welded together. When the fixing plate 356 is applied, a groove into which the fixing plate 356 is inserted may be formed in the lower portion of the first current collector 332.

The first terminal plate 354 may be disposed on the uppermost end of the first terminal part 350 and may be made of a conductive material to electrically connect the outside and the secondary battery 10. The first terminal plate 354 may have a substantially plate shape and may be disposed parallel to the upper end of the electrode assembly 100. The first terminal plate 354 has a terminal hole (e.g., an opening) through which the first terminal pin 352 is inserted. When the first terminal pin 352 is inserted into the cap plate 310, the first terminal plate 354 is seated on the flange 352a of the first terminal pin 352. Thereafter, by pressing and deforming the upper end of the first terminal pin 352, the first terminal plate 354 may be coupled to the first terminal pin 352 and fixed thereto.

With the aforementioned structure, a current path from the first electrode plate 110 of the electrode assembly 100 to the first substrate tab 112, the sub-plate 336, the connection plate 334, the first current collector 332, the first terminal pin 352, and the first terminal plate 354 may be formed.

As shown in FIGS. 2 to 4, the second current collecting unit 340 has the same or substantially the same configuration as the first current collecting unit 330 and is disposed to be symmetrical with the first current collecting unit 330 to be electrically connected to the second electrode plate 120. A detailed description about the second current collecting unit 340 may be omitted.

As shown in FIGS. 2 to 4, the second terminal part 360 may include a second terminal pin 362, a second terminal plate 364, a conductive plate 366, and a fixing plate 368. The second terminal pin 362, the second terminal plate 364, and the fixing plate 368 may have the same configurations as the corresponding elements of the first terminal part 350 and may be arranged to be symmetrical with the first terminal part 350.

The conductive plate 366, which is specific to the second terminal part 360, is disposed between the second terminal plate 364 and the cap plate 310. The conductive plate 366 may have a rectangular plate shape substantially corresponding to the shape of the second terminal plate 364. The conductive plate 366 is formed to be larger than the second terminal plate 364 and has a groove in which the second terminal plate 364 is seated. A through hole (e.g., an opening) is formed through the conductive plate 366 at a position corresponding to the terminal hole 312 in the cap plate 310. A flange 362a of the second terminal pin 362 is disposed in the through hole in the conductive plate 366. For example, the conductive plate 366 may be made of a conductive resin material and may be made by an injection process. The conductive plate 366 electrically connects the second terminal plate 364, which is electrically connected to the second terminal pin 362 and the cap plate 310. Accordingly, the cap plate 310 is electrically connected to the second electrode plate 120 because it is connected to the second current collecting unit 340 by the second terminal part 360. Therefore, the cap plate 310 has a positive polarity, which is the same as the second current collecting unit 340, and the case 200, which is welded to the cap plate 310, also has a positive polarity.

As described above, the second current collecting unit 340 has the same or substantially the same configuration as the first current collecting unit 330. Therefore, because the relatively thick second current collector 342 is formed in a straight line and the connection plate 334 and the sub-plate 336 are relatively thin, the size of the electrode assembly 100 can be increased and a space for the same secured.

According to embodiments of the present disclosure, by reducing the space occupied by a current collecting structure in the longitudinal direction of an electrode assembly, a space to increase the size of the electrode assembly can be secured. The foregoing embodiments is an example embodiment of the present disclosure, and the present disclosure is not limited to the embodiments described herein. It will be understood by a person skilled in the art that various changes in the form and details may be made to the described embodiments without departing from the spirit and scope of the present disclosure as defined by the following claims and their equivalents.

What is claimed is:

1. A secondary battery comprising:
a case having an opening at one side thereof;
an electrode assembly accommodated in the case, the electrode assembly comprising:
a first electrode plate having a first substrate tab on one side of the electrode assembly in the longitudinal direction of the case;
a second electrode plate having a second substrate tab on another side of the electrode assembly in the longitudinal direction of the case; and
a separator between the first electrode plate and the second electrode plate; and
a cap assembly comprising:
a cap plate coupled to the case at the opening therein;
a first current collecting unit comprising a first current collector parallel to an upper end of the electrode assembly in the longitudinal direction and electrically connected to the first electrode substrate tab;
a second collecting comprising a second current collector parallel to the upper end of the electrode assembly in the longitudinal direction and electrically connected to the second electrode substrate tab;
a first terminal part electrically connected to the first current collecting unit;
a second terminal part electrically connected to the second current collecting unit; and
a plurality of insulating members coupled to at least one of the cap plate, the first current collector, the second current collector, the first terminal part and the second terminal part.

2. The secondary battery of claim 1, wherein the first current collecting unit further comprises:
a connection plate electrically connected to the first current collector and having one end bent in the direction of the first substrate tab; and
a sub-plate electrically connected to the connection plate and the first substrate tab, and
wherein the second current collecting unit further comprises:
a connection plate electrically connected to the second current collector and having one end bent in the direction of the second substrate tab; and
a sub-plate electrically connected to the connection plate and the second substrate tab.

3. The secondary battery of claim 2, wherein the sub-plate of the first current collecting unit comprises a first connection part electrically connected to the connection plate and a second connection part electrically connected to the first substrate tab, and
wherein the sub-plate of the second current collecting unit comprises a first connection part electrically connected to the connection plate and a second connection part electrically connected to the second substrate tab.

4. The secondary battery of claim 3, wherein one end of the connection plate and the first connecting part of the sub-plate are welded to each other.

5. The secondary battery of claim 3, wherein the welded portion of the connection plate and the sub-plate is closer to the bottom surface of the case than to the top of the electrode assembly.

6. The secondary battery of claim 3, wherein the second connection part of the sub-plate is bent toward the electrode assembly from the first connection part, and
wherein the bent portion is closer to the bottom surface of the case than to the top end of the electrode assembly.

7. The secondary battery of claim 6, wherein a plate surface of the second connection part facing the electrode assembly is on the same plane as a plate surface of the connection plate facing the electrode assembly.

8. The secondary battery of claim 6, wherein a plate surface of the second connection part facing the electrode assembly is closer to the electrode assembly than to a plate surface of the connection plate facing the electrode assembly.

9. The secondary battery of claim 8, wherein the second connection part has a welding groove concavely formed on the plate surface facing the case.

10. The secondary battery of claim 2, wherein the thickness of the first current collector or the second current collector is greater than the thickness of the connection plate and the sub-plate.

11. The secondary battery of claim 10, wherein the thickness of the first current collector or the second current collector is four to five times that of the connection plate and the sub-plate.

12. A secondary battery comprising:
an electrode assembly;
a case accommodating the electrode assembly; and
a cap assembly coupled to the case, electrically connected to the electrode assembly, and having a first current collector and a second current collector parallel to the upper end of the electrode assembly.

13. The secondary battery of claim 12, wherein the cap assembly comprises:
a cap plate coupled to the case;
a first current collecting unit comprising a sub-plate electrically connected to a first substrate tab on a first electrode plate of the electrode assembly and a connection plate electrically connected to the first current collector and the corresponding sub-plate;
a second current collecting unit comprising a sub-plate electrically connected to a second substrate tab on a second electrode plate of the electrode assembly and a connection plate electrically connected to the second current collector and the corresponding sub-plate;
a first terminal part comprising a first terminal pin coupled to the first current collector and electrically connected thereto and a first terminal plate coupled to the first terminal pin and electrically connected to the first terminal plate;
a second terminal part comprising a second terminal pin coupled to the second current collector and electrically connected thereto, a second terminal plate coupled to the second terminal pin and electrically connected to the second terminal plate, and a conductive plate; and
an insulating member comprising insulating material and arranged between the cap plate and the first current collector, between the first current collector and the electrode assembly, between the second current collector and the electrode assembly, and between the first terminal pin and the second terminal pin and the cap plate, respectively.

14. The secondary battery of claim 13, wherein the connection plate has one end disposed parallel to the first current collector or the second current collector and another end bent toward the electrode assembly, and
wherein the sub-plate is welded to an end of the bent portion.

15. The secondary battery of claim 14, wherein the sub-plate comprises a first connection part welded to the connection plate and a second connection part bent from the first connection part toward the electrode assembly and electrically connected to the electrode assembly.

16. The secondary battery of claim 15, wherein the second connection part is on the same plane as the connection plate or closer to the electrode assembly than to the connection plate.

17. The secondary battery of claim 16, wherein the thickness of the first current collector or the second current collector is greater than that of the connection plate and the sub-plate.
